(19) United States
(12) Patent Application Publication
(10) Pub. No.: US 2017/0139071 A1
(43) Pub. Date: May 18, 2017

(54) ACOUSTIC DEBLURRING FOR DOWNWELL SENSORS

(71) Applicant: Halliburton Energy Services, Inc., Houston, TX (US)

(72) Inventors: Christopher Lee Stokely, Houston, TX (US); Andreas Ellmauthaler, Rio de Janeiro (BR)

(21) Appl. No.: 15/129,900

(22) PCT Filed: May 27, 2014
(86) PCT No.: PCT/US2014/039548

§ 371 Date: Sep. 28, 2016

(51) Int. Cl. G01V 1/48; E21B 47/12

(52) U.S. Cl. CPC G01V 1/48; E21B 47/123

(57) ABSTRACT

A distributed acoustic sensor, such as a fiber optic acoustic sensing system, can be used in a wellbore to detect pressure fluctuations indicative of events occurring in the wellbore. Sensed data from the distributed acoustic sensor can be deblurred to enhance spatial resolution. The sensed data can be combined with a point-spread function determined from a calibration process to deblur the sensed data. Compressive sensing can also be used, alone or in conjunction with calibration, to determine the most-likely accurate results from the sensed data.

### TECHNICAL FIELD

The present disclosure relates to downwell sensing generally and more specifically to spatially enhancing distributed acoustic sensing.

### BACKGROUND

Hydrocarbons can be produced from wellbores drilled from the surface through a variety of producing and non-producing formations. Various events can occur downwell, such as tubing leaks, water injection, gas entry, sand entry, operation of mechanical equipment, and other occurrences. Each event can produce detectable acoustic activity within the wellbore.

Additionally flow of fluids or material within a wellbore, especially non-laminar flow, can generate detectable acoustic activity within the wellbore. It can be desirable to determine the density, flow rate, and other aspects of fluids or material within a wellbore, especially with respect to spatial location. Precise determination of a location of a sensed measurement or event can be particularly challenging.

### BRIEF DESCRIPTION OF THE DRAWINGS

The specification makes reference to the following appended figures, in which use of like reference numerals in different figures is intended to illustrate like or analogous components

FIG. 1 is a cross-sectional schematic view of a wellbore including a fiber optic acoustic sensing subsystem according to one embodiment.

FIG. 2 is a cross-sectional schematic view of a wellbore including a fiber optic acoustic sensing subsystem according to another embodiment.

FIG. 3 is a cross-sectional schematic view of a wellbore including a fiber optic acoustic sensing subsystem according to another embodiment.

FIG. 4 is a cross-sectional side view of a two-fiber acoustic sensing system according to one embodiment.

FIG. 5 is a cross-sectional view of tubing with fiber optic cables positioned at different angular positions external to the tubing according to one embodiment.

FIG. 6 is a cross-sectional view of tubing with fiber optic cables positioned at different angular positions external to the tubing according to another embodiment.

FIG. 7 is a flow chart depicting a calibration process and a measurement process according to one embodiment.

FIG. 8 is a flow chart depicting calibrating a distributed acoustic sensor according to one embodiment.

FIG. 9 is a flow chart depicting deblurring according to one embodiment.

FIG. 10 is a flow chart depicting the application of a compressive sensing algorithm according to one embodiment.

### DETAILED DESCRIPTION

Certain aspects and features relate to deblurring (e.g., enhancing spatial resolution of) distributed acoustic sensor data from a wellbore environment. A distributed acoustic sensor, such as a fiber optic acoustic sensing system, can be used in a wellbore to detect pressure fluctuations indicative of attributes (e.g., density, flow rate, or others) of materials or fluids in the wellbore, as well as events occurring in a wellbore environment. A processor can process the sensed data based with respect to location. The sensed data can be combined with a point-spread function determined from a calibration process to deblur the sensed data. Compressive sensing can be used to determine the most-likely accurate results from the sensed data. The deblurring and compressive sensing can be used alone or in combination to provide enhanced spatial resolution of the sensed data.

In a wellbore, events such as leaks, water injection, gas entry, sand entry, operation of mechanical equipment, and others can be sensed by an acoustic sensor, such as a fiber optic distributed acoustic sensor. Light can be transmitted down a fiber optic cable and a fiber optic interrogator can measure reflections, such as reflections from Rayleigh scattering or Bragg gratings. A distributed acoustic sensor can have a nontrivial spatial resolution response to acoustic activity that depends on the acoustic frequency imparted to the fiber optic cable, as well as acoustic coupling factors, such as well construction, reservoir or formation properties, or other properties. Attempts to decreasing spatial resolution can degrade the quality of the measured acoustic signal.

Because a wellbore is generally tube-shaped, a sound at one location can travel down the tube and acoustically illuminate spatially large regions of the distributed acoustic sensor. Acoustics in a long tube can support exotic or unusual acoustic properties related to possible modes and cutoff frequencies.

A measured acoustic signal can be deblurred to increase the spatial resolution without sacrificing the quality of the measured acoustic signal. Spatial resolutions of 10 meters to 25 meters or better can be achieved. Spatial resolutions of 1 meter to 10 meters can be achieved. Spatial resolutions of under 3 meters can be achieved.

In some embodiments, a measured acoustic signal can be deblurred by combining the measured acoustic signal with an acoustic point spread function using a deblurring algorithm. Examples of deblurring algorithms include the Wiener deblurring filter, regularized deblurring filter, Lucy-Richardson deblurring algorithm, blind deconvolution deblurring algorithm, Vardi-Lee expectation maximization deblurring algorithm, Vertebi methodologies, Tikhonov regularization, Backus-Gilbert techniques, or Phillips-Twomey regularization.

The acoustic point spread function can be determined by a calibration process in which calibration sounds (e.g. single-frequency tones, dual tone multiple frequency tones, multiple-frequency tones, wide-spectrum tones, white noise, colored noise, repeating swept-frequency waveforms, pseudorandom waveforms, or other repeating complex waveforms) can be emitted from a sound generator (e.g., a speaker) that is inserted downwell on a line. A point-spread function as a function of location can be measured based on the calibration tones and the amount of line that has been inserted downwell. The calibration sounds can be pulsed or continuous and can be transmitted from multiple sound generators at different locations in the wellbore.

Calibration sounds can be transmitted in synchrony and can be transmitted at different volumes at various locations. If sounds are transmitted at different volumes at various locations, nonlinearities in the gain response as a function of location in the well can be determined. In some embodiments, a calibration sound (e.g., a known acoustic activity or a perfectly deblurred acoustic signal) will generate a distribution of signals on the distributed acoustic sensor. This distribution of signals may be non-Gaussian due to various factors (e.g., distortions from tubing, rock, cement, or other). A point spread function can be determined to account for such distortions. In some embodiments, the point spread function can be determined as a function of frequency and location in the wellbore. While a calibration process can be performed as often as desired, a particular point spread function for a wellbore can remain sufficiently accurate for a long time.

In some embodiments, the acoustic point spread function can be estimated using data collected from another wellbore, such as calibration data from a similar wellbore in the same or a different formation. In some embodiments, the acoustic point spread function can be estimated using data collected from a digital model, such as a digital model of a wellbore environment. In some embodiments, the acoustic point spread function can be estimated using data collected from a physical model, such as a physical model of a wellbore environment.

In some embodiments, a Vardi-Lee deblurring algorithm can be used to deblur a measured acoustic signal. The measured acoustic signal can be defined using Equation 1.

m(z)=∫ n(x)·p(z|x)dx Equation 1

where m(z) is the distribution of the measured acoustic signal parameter z (e.g., representing the measured acoustic signal), n(x) is the estimated distribution of the deblurred acoustic signal x (e.g., representing the deblurred acoustic signal or the actual acoustic activity of the wellbore), and p(z|x) is the normalized conditional probability distribution (e.g., point spread function) that gives the probability distribution for an acoustic signal given a known deblurred acoustic signal. p(z|x) can be determined from controlled laboratory measurements, theoretical models, or a calibration process.

Equation 1 can be discretized as shown in Equation 2.

$${m}_{j} = {\sum }_{i} {n}_{i} \cdot {p}_{i , j} \qquad Equation 2$$

Equation 2 can be solved using various regularization methods. Examples of regularization methods include Tikhonov regularization, Phillips-Twomey regularization, Backus-Gilbert regularization, and others. Equation 2 can also be solved using an expectation-maximization technique.

The expectation-maximization technique includes starting with an initial guess nᵢ⁽⁰⁾ to obtain the next best estimate nᵢ⁽¹⁾ as shown in Equation 3.

$${n}_{i}^{( 1 )} = {n}_{i}^{( 0 )} \cdot {\sum }_{j} \frac{{m}_{j} \cdot {p}_{i , j}}{( {\sum }_{k} {n}_{k}^{( 0 )} \cdot {p}_{k , j} )} \qquad Equation 3$$

The result nᵢ⁽¹⁾ can be iterated again to find the next best estimate nᵢ⁽²⁾ as shown in Equation 4.

$${n}_{i}^{( 2 )} = {n}_{i}^{( 1 )} \cdot {\sum }_{j} \frac{{m}_{j} \cdot {p}_{i , j}}{( {\sum }_{k} {n}_{k}^{( 1 )} \cdot {p}_{k , j} )} \qquad Equation 4$$

The result nᵢ⁽²⁾ can be further iterated numerous times, where each new estimate of the distribution nᵢ is used in each subsequent iteration. Additionally p_{i,j} can be normalized as shown in Equation 5.

$${\sum }_{j} {p}_{i , j} = 1 \qquad Equation 5$$

The criterion for convergence can be related to minimizing a goodness-of-fit parameter (e.g., the Kullback-Leibler information divergence) given by Equation 6.

$$L = {\sum }_{j} \{ {m}_{j} \cdot ln ( {\sum }_{i} {n}_{i} \cdot {p}_{i , j} ) - {\sum }_{i} {n}_{i} \cdot {p}_{i , j} \} \qquad Equation 6$$

The goodness-of-fit parameter can be iterated numerous times. The goodness-of-fit parameter can be iterated until the percent change is below some tolerance estimate ε given by Equation 7.

$$\frac{\vert {L}^{( 1 )} - {L}^{( 0 )} \vert}{\vert {L}^{( 0 )} \vert} < ɛ \qquad Equation 7$$

where superscripts “(0)” and “(1)” indicate the values associated with the goodness-of-fit parameter before and after an iteration, respectively. In some embodiments, Equation 3 can be iterated ten times.

Once a distribution for n is estimated, the uncertainty in n can be estimated., such as using Bayes' theorem as shown in Equation 8.

p(x|z)·p(z)=p(z|x)·p(x) Equation 8

where z is the acoustic signal and x is the deblurred acoustic signal. Additionally, p(z) and p(x) are the normalized distribution of the measured acoustic signal m(z) and the estimated deblurred acoustic signal n(x), respectively. The normalized conditional probability distribution p(z|x) provides the distribution of measured acoustic signal given a deblurred acoustic signal. Since p(z), p(x), and p(z|x) are now known, p(x|z) can be estimated as shown in Equation 9.

$$p ( x \vert z ) = \frac{p ( z \vert x ) \cdot p ( x )}{p ( z )} \qquad Equation 9$$

The result p(x|z) gives the distribution in the deblurred acoustic signal given a measured distributed in acoustic signal.

In some embodiments, the full width half max of distribution p(x|z) can be assigned to additionally determine the uncertainty window on the estimated deblurred acoustic signal.

Variations to the aforementioned algorithms can be made to provide frequency dependent deblurring.

In addition to deblurring, compressive sensing can be used on a measured acoustic signal to enhance spatial resolution. Compressive sensing may work in fewer instances than deblurring, but compressive sensing can provide better spatial resolution than deblurring.

In compressive sensing, it is assumed that the number of events along a wellbore is sparse. An assumption can be made that the number of events (e.g., leaks) is smaller than the number of spatial measurements of the distributed acoustic sensor. For example, if detecting a leak, it may be assumed that the number of leaks is 1, 2, 3, or 4. Any other numbers can be used as appropriate. In the example, a processor can analyze the measured acoustic signal based on the assumption that the number of leaks is 1, 2, 3, or 4, in order to create a set of possible solutions. A processor can compare each possible solution in the set to determine the solution that is most likely to be accurate and output that solution. In some embodiments, the set or a subset of possible solutions can be output.

The possible locations for an acoustic signal or acoustic activity (e.g., a leak or other event) can be extremely high or even infinite along the length of the wellbore, resulting in an extremely high or infinitely high resolution for an acoustic activity. However, the distributed acoustic sensor has a limited resolution that is likely lower than the resolution of the acoustic activity. Forward mapping of a high-resolution acoustic activity to a low-resolution measured acoustic signal can be shown by Equation 10.

a=Db Equation 10

where b=[b₁, b₂, . . . , b_{N}] defines the acoustic activity (e.g., leak or other event) at a given frequency and time along the wellbore, and a=[a₁, a₂, . . . , a_{M}] defines the measured acoustic signal. D is a linear mapping function that is a M×N matrix where M<<N. D can be initially estimated from a calibration step, from an acoustic model, or from a combination of an acoustic model further refined through calibration.

In an embodiment, it can be assumed that b is a sparse vector with very few non-zero coefficients. This assumption may be valid if it is true that few acoustic activities (e.g., leaks or other events) are occurring. Equation 11 can be used.

$${min}_{b} {‖ b ‖}_{0} subject to a = Db \qquad Equation 11$$

where ∥·∥₀ is the non-convex lₒ norm which counts the number of non-zero elements within a given vector.

Several conditions can be imposed on the high-resolution vector b as well as on the forward mapping matrix D in order for the solutions of the l₀ and the l₁ norm to coincide. In an embodiment the aforementioned conditions can be phrased in terms of “mutual coherence” of the forward mapping matrix D (e.g., measuring the smallest angle between each pair of the columns of D) as well as of the “restricted isometry property” (e.g., measuring the degree to which each submatrix of D is close to being an isometry). For example, based on the calibration data, the forward mapping matrix D can be determined with the aforementioned conditions in mind, such as by following a “dictionary learning” methodology (e.g., the K-SVD algorithm). By way of further example, the “quality” of the forward mapping matrix D (e.g., to what extent D satisfies the aforementioned conditions) influences the design of the high-resolution vector b. For example, if the low-resolution vector a comprises 10 measurements corresponding to a 10 m spatial resolution and the “quality” of D is good, one can a-priori determine b to comprise of 100 elements at 1 m spatial resolution which we then populate using Equation 12, below. If, on the other hand, D has a low “mutual coherence” and a low-order “restricted isometry” b may be limited to 50 elements giving a 2 m spatial resolution.

When the lₒ norm of Equation 11 can be substituted by the closest convex norm, namely the l₁ norm, the following minimization equation, Equation 12, can be used.

$${min}_{b} {‖ b ‖}_{1} subject to a = Db \qquad Equation 12$$

In some embodiments, noise can be compensated for by using Equation 13.

$${min}_{b} {‖ b ‖}_{1} subject to {‖ Db - a ‖}_{2}^{2} \leq ε \qquad Equation 13$$

for ε>0.

The aforementioned compressive sensing approach work under the assumption that vector b is sparse. In many embodiments, only a confined number of acoustic sources exist along a wellbore. Compressive sensing can improve spatial resolution of the distributed acoustic sensor and also improve the capability of the distributed acoustic sensor to localize the individual acoustic sources with very high precision.

As described above, D can be initially estimated using an acoustic model. D can also be initialized using the calibration data or by using a combination of the calibration data and an acoustic model. The element of matrix D at row i and column j can convey how much attenuation a signal suffers when it is emitted at position i and received by the distributed optical sensor at region j. Initially, a narrowband signal emitted at a given position s can be described as shown in Equation 14

x_{s (}t)=Ae^{jωt} Equation 14

where ω is the signal's frequency and A is the signal's amplitude. The acoustic model can assume that the distributed acoustic sensor is a line oriented along a z axis, the signal is a point source, and the transmission medium is homogenous. The resultant received signal received by a particular distributed acoustic sensor region c can be defined as shown in

Equation 15.

$$\begin{matrix}{r}_{c} ( t ) = [ \frac{1}{{K}_{s , c}} {\int }_{c}^{c + Z} {e}^{j ω {τ}_{s , c} ( z )} d z ] A {e}^{j ω t} \\ = {H}_{s , c} ( ω ) A {e}^{j ω t}\end{matrix} \qquad Equation 15$$

where, Z is the length of the fiber sensing region, K_{s,c} is the propagation attenuation of the acoustic wave and τ_{s,c}(z) is the time of flight between positions s and c. Equation 15 can be an element of matrix D relating how much the acoustic activity's amplitude is changed when measured.

In an example, considering source positions b₁, b₂, . . . and sensing positions a₁, a₂, . . . , an initial assumption for matrix D can be written as shown in Equation 16.

$$D = [ \begin{matrix}{H}_{{b}_{1} , {a}_{1}} ( ω ) & {H}_{{b}_{2} , {a}_{1}} ( ω ) & … \\ {H}_{{b}_{1} , {a}_{2}} ( ω ) & {H}_{{b}_{2} , {a}_{2}} ( ω ) & … \\ ⋮ & ⋮ & ⋱\end{matrix} ] \qquad Equation 16$$

A different D matrix can be determined for different frequencies. An equivalent model can be obtained for the energy of the acoustic activity as well where cross-terms can be ignored.

In some embodiments, the spatial resolution of a measured acoustic signal can be enhanced using a combination of deblurring and compressive sensing. In some embodiments, the spatial resolution of a measured acoustic signal can be enhanced using one of deblurring and compressive sensing. In some embodiments, a first enhanced signal that has been deblurred is compared with a second enhanced signal that has been enhanced using compressive sensing. If the second enhanced signal appears to be accurate given the first enhanced signal, the second enhanced signal can be further used (e.g., analyzed or output).

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may be drawn not to scale.

The term “machine-readable medium” includes, but is not limited to, portable or non-portable storage devices, optical storage devices, wireless channels, and various other mediums capable of storing, containing or carrying instruction(s) and/or data. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Systems depicted in some of the figures may be provided in various configurations. In some embodiments, the systems may be configured as a distributed system where one or more components of the system are distributed across one or more coupled devices.

Individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc.

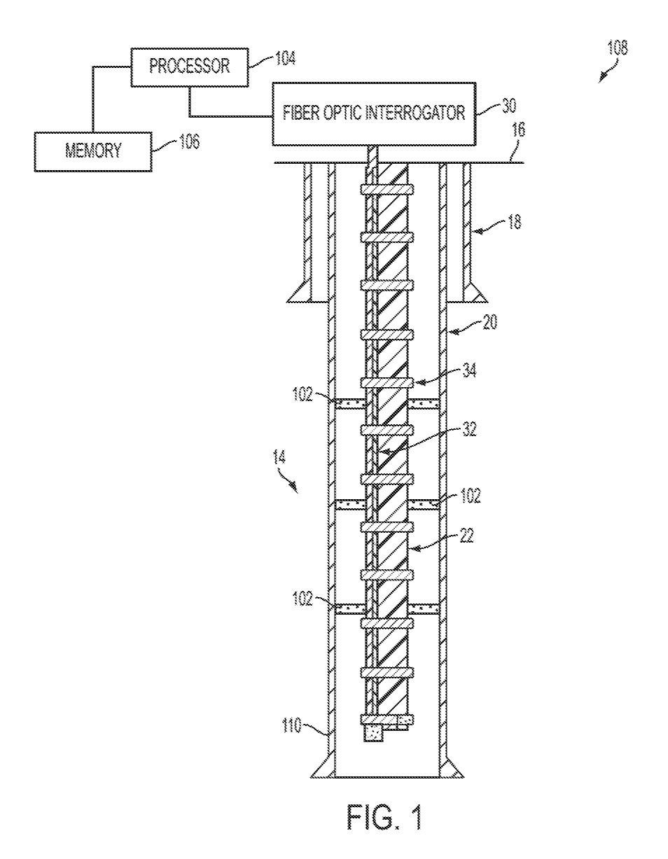

FIG. 1 depicts an example of a wellbore system 108 that includes a fiber optic acoustic sensing subsystem according to one embodiment. The system 108 can include a wellbore 110 that penetrates a subterranean formation 14 for the purpose of recovering hydrocarbons, storing hydrocarbons, disposing of carbon dioxide (which may be referred to as a carbon dioxide sequestration), or the like. The wellbore 110 may be drilled into the subterranean formation 14 using any suitable drilling technique. While shown as extending vertically from the surface 16 in FIG. 1, in other examples the wellbore 110 may be deviated, horizontal, or curved over at least some portions of the wellbore 110. The wellbore 110 can include a surface casing 18, a production casing 20, and tubing 22. The wellbore 110 may be, also or alternatively, open hole and may include a hole in the ground having a variety of shapes or geometries.

The tubing 22 can extend from the surface 16 in an inner area defined by production casing 20. The tubing 22 may be production tubing through which hydrocarbons or other fluid can enter and be produced. In other aspects, the tubing 22 is another type of tubing. The tubing 22 may be part of a subsea system that transfers fluid or otherwise from an ocean surface platform to the wellhead on the sea floor.

Some items that may be included in the wellbore system 108 have been omitted for simplification. For example, the wellbore system 108 may include a servicing rig, such as a drilling rig, a completion rig, a workover rig, other mast structure, or a combination of these. In some aspects, the servicing rig may include a derrick with a rig floor. Piers extending downwards to a seabed in some implementations may support the servicing rig. Alternatively, the servicing rig may be supported by columns sitting on hulls or pontoons (or both) that are ballasted below the water surface, which may be referred to as a semi-submersible platform or rig. In an off-shore location, a casing may extend from the servicing rig to exclude sea water and contain drilling fluid returns. Other mechanical mechanisms that are not shown may control the run-in and withdrawal of a workstring in the wellbore 110. Examples of these other mechanical mechanisms include a draw works coupled to a hoisting apparatus, a slickline unit or a wireline unit including a winching apparatus, another servicing vehicle, and a coiled tubing unit.

The wellbore system 108 includes a fiber optic acoustic sensing subsystem that can detect acoustics or other vibrations in the wellbore 110, such as during a stimulation operation. The fiber optic acoustic sensing subsystem includes a fiber optic interrogator 30 and one or more fiber optic cables 32, which can be or include sensors located at different zones of the wellbore 110 that are defined by packers 102. The fiber optic cables 32 can contain single mode optical fibers, multi-mode optical fibers, or multiple fibers of multiple fiber types. The fiber optic cables 32 can be coupled to the tubing 22 by couplers 34 (e.g., clamps). In some aspects, the couplers 34 are cross-coupling protectors located at every other joint of the tubing 22. The fiber optic cables 32 can be communicatively coupled to the fiber optic interrogator 30 that is at the surface 16.

The fiber optic interrogator 30 can output a light signal to the fiber optic cables 32. Part of the light signal can be reflected back to the fiber optic interrogator 30. The interrogator can perform interferometry and other analysis using the light signal and the reflected light signal to determine how the light is changed as it travels along the cables or interacts with sensors in the cables, which can reflect sensor changes that are measurements of the acoustics in the wellbore 110.

A processor 104 can be communicatively coupled to the fiber optic interrogator 30 to process the measurements of the acoustics in the wellbore 110 as described in further detail below. The processor 104 can be one or more processors incorporated in one or more housings. The processor 104 may be the fiber optic interrogator 30.

The processor 104 can be communicatively coupled to a memory 106. The memory 106 can be a processor-readable memory that stores instructions (e.g., programming code) that causes the processor 104 to perform the functions described herein. The memory 106 can also store data, such as calibration data. In some embodiments, the memory 106 can be located in whole or in part on a removable medium, such as a compact disk or a flash drive.

Fiber optic cables according to various aspects can be located in other parts of a wellbore. For example, a fiber optic cable can be located on a retrievable wireline or external to a production casing.

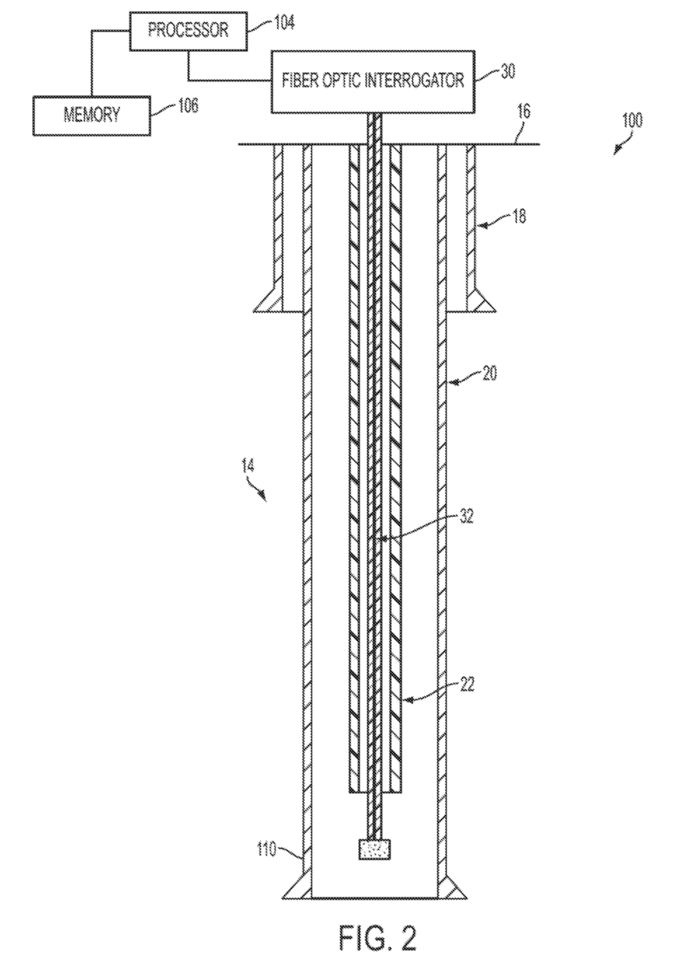

FIG. 2 depicts a wellbore system 100 that is similar to the wellbore system 108 in FIG. 1 according to one embodiment. It includes the wellbore 110 through the subterranean formation 14. Extending from the surface 16 of the wellbore 110 is the surface casing 18, the production casing 20, and tubing 22 in an inner area defined by the production casing 20. The wellbore system 100 includes a fiber optic acoustic sensing subsystem. The fiber optic acoustic sensing subsystem includes the fiber optic interrogator 30 and the fiber optic cables 32. The fiber optic cables 32 are on a retrievable wireline.

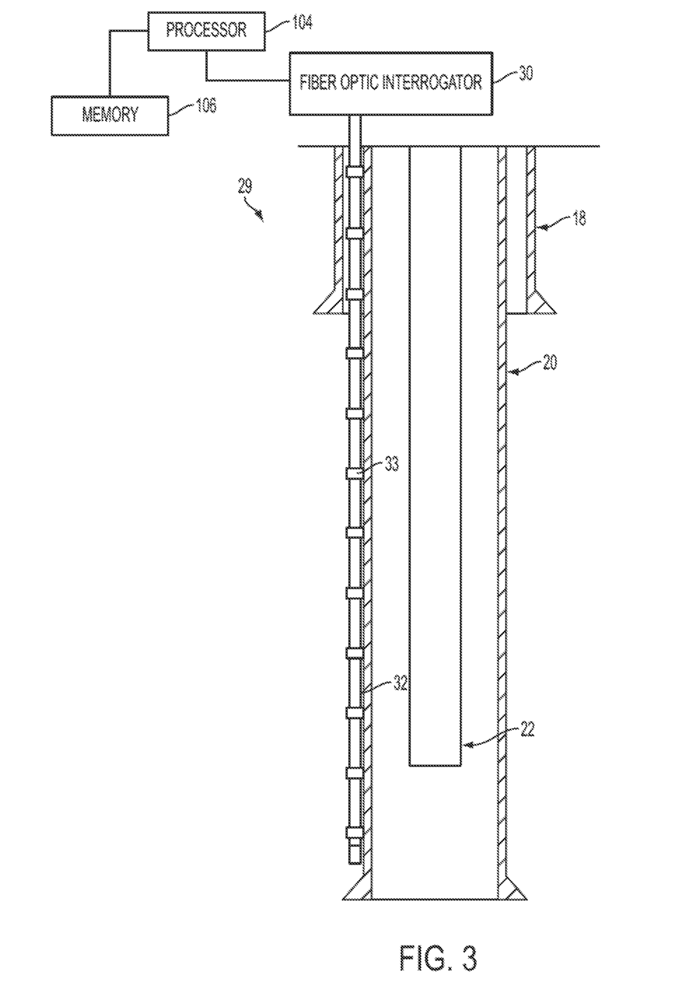

FIG. 3 depicts an example of a wellbore system 29 that includes a surface casing 18, production casing 20, and tubing 22 extending from a surface according to one embodiment. The fiber optic acoustic sensing subsystem includes a fiber optic interrogator and the fiber optic cables 32. The fiber optic cables 32 are positioned external to the production casing 20. The fiber optic cables 32 can be coupled to the production casing 20 by couplers 33.

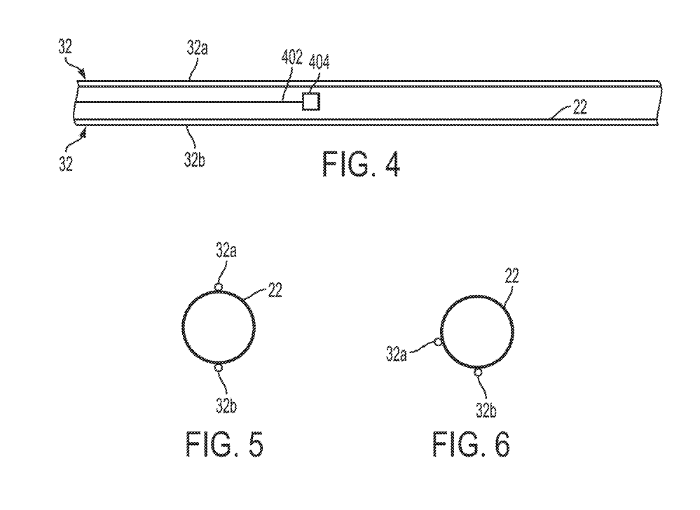

FIG. 4 is a cross-sectional side view of an example of the tubing 22 and the fiber optic cables 32. The fiber optic cables 32 are positioned external to the tubing 22. The fiber optic cables 32 can include any number of cables. The fiber optic cables 32 in FIG. 4 include two cables: fiber optic cable 32a and fiber optic cable 32b. The fiber optic cables 32 may sense acoustic activity using Rayleigh backscatter distributed acoustic sensing.

A line 402 is shown supporting a sound generator 404. The sound generator 404 can be used during a calibration process to calibrate the distributed acoustic sensor, as described in further detail below. A line 402 can include one or more sound generators 404 at different locations.

Fiber optic cable 32a and fiber optic cable 32b can be positioned at different angular positions relative to each other and external to the tubing 22. FIGS. 5 and 6 depict cross-sectional views of examples of the tubing 22 with fiber optic cables 32 positioned at different angular positions external to the tubing 22. In FIG. 5, fiber optic cable 32a is positioned directly opposite from fiber optic cable 32b. In FIG. 6, fiber optic cable 32a is positioned approximately eighty degrees relative to fiber optic cable 32b. Any amount of angular offset can be used. The angular positions of the fiber optic cables 32 may be used for common mode noise rejection. For example, a difference in acoustical signals from the fiber optic cables 32 at different angular locations on the tubing 22 can be determined. The difference may be filtered to remove high or low frequencies, such as a sixty hertz power frequency associated with the frequency of alternating current electricity used in the United States. A statistical measure of that difference signal, which is the variance, root mean square, or standard deviation, can be performed to determine the acoustic activity or properties thereof. For example, the fluid density can be characterized based on a known flow rate of the fluid that is measured at the surface or controlled. Moreover, other aspects of the fluid related to the proportionality constant can be characterized through a calibration process since the fluid introduced into the wellbore for stimulation can be controlled.

Distributed sensing of acoustic activity at one or more downhole locations as in the figures or otherwise can be useful in monitoring flow downhole during stimulation operations. In some aspects, a fiber optic cable includes a sensor that is a stimulation fluid flow acoustic sensor. The sensor is responsive to acoustic energy in stimulation fluid in a wellbore by modifying light signals (e.g., generate light signal modifications) in accordance with the acoustic energy. The sensor may be multiple sensors distributed in different zones of a wellbore. The sensor may be the fiber optic cable itself, fiber Bragg gratings, coiled portions of the fiber optic cable, spooled portions of the fiber optic cable, or a combination of these. The fiber optic interrogator may be an event-sensing fiber optic interrogator that is response to light signals modified in accordance with the acoustic energy (e.g., acoustic activity) received from the fiber optic cable by determining properties (e.g., time, location, measurements, and other properties) of an event.

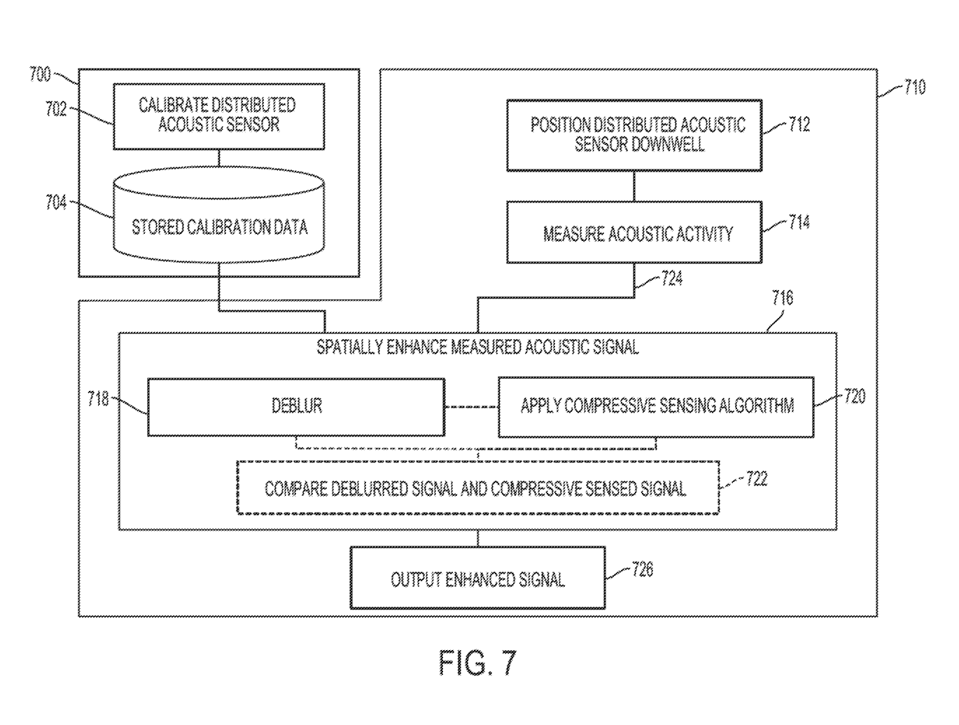

FIG. 7 is a flow chart depicting a calibration process 700 and a measurement process 710 according to one embodiment. In a calibration process 700, a distributed acoustic sensor can be calibrated at block 702 and the calibration data can be stored at block 704. The calibration data can include data necessary to calibrate the distributed acoustic sensor. The calibration data can include one or more distributions representing measurements from the distributed acoustic sensor of a known acoustic activity. The one or more distributions representing measurements from the distributed acoustic sensor can include one or more point spread functions.

During a measurement process 710, a distributed acoustic sensor can be positioned downwell at block 712. At block 714, the distributed acoustic sensor can measure an acoustic activity that occurs in the wellbore. The acoustic activity can represent one or more events that occur in the wellbore, such as leaks, water injection, gas entry, sand entry, operation of mechanical equipment (e.g., tools), and other events. A measured acoustic signal 724 (e.g., measurements of the acoustics of the wellbore) can be provided to the processor.

At block 716, the measured acoustic signal 724 can be spatially enhanced, by the processor, to provide enhanced spatial resolution beyond the spatial resolution of the measured acoustic signal 724. Spatially enhancing the measured acoustic signal can utilize the calibration data stored at block 704 (e.g., stored on memory 106 ). Spatially enhancing the measured acoustic signal can include one or both of deblurring the measured signal at block 718 and applying a compressive sensing algorithm to the measured acoustic signal at block 720.

In some embodiments, deblurring the measured signal at block 718 can output a first enhanced signal and applying a compressive sensing algorithm to the measured acoustic signal at block 720 can output a second enhanced signal. Spatially enhancing the measured acoustic signal can further include, at optional block 722, comparing the first enhanced signal and the second enhanced signal. Compressive sensing algorithms can provide superior spatial enhancement than deblurring, but may be inaccurate in cases where the acoustic activity is not sparsely populated. At optional block 722, if the second enhanced signal is sufficiently congruent with the first enhanced signal, the second enhanced signal can be used further. If the second enhanced signal is not sufficiently congruent with the first enhanced signal, it can be assumed that the acoustic activity is not sparsely populated and the first enhanced signal can be used further.

In some embodiments, the measured acoustic signal can be deblurred at block 718, resulting in a first enhanced signal. At block 720, a compressive sensing algorithm can be applied to the first enhanced signal, resulting in a second enhanced signal. The second enhanced signal can be used further.

The result of spatially enhancing the measured acoustic signal at block 716 can be an enhanced signal that is output at block 726.

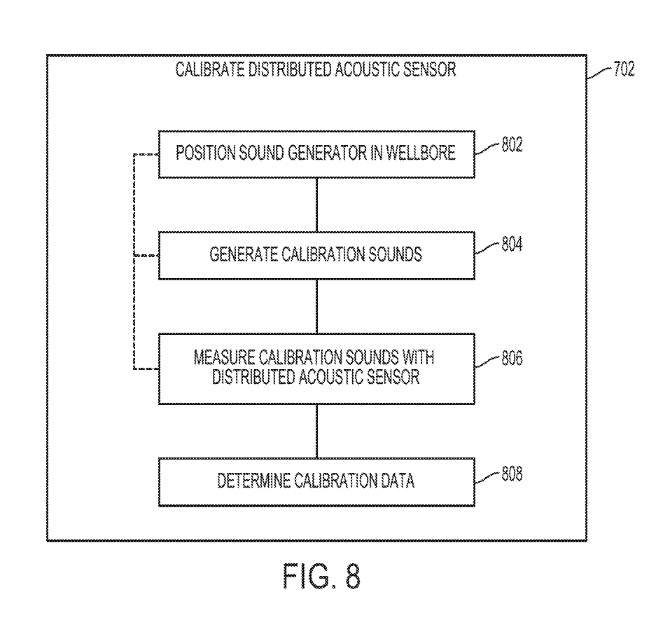

FIG. 8 is a flow chart depicting calibrating a distributed acoustic sensor according to one embodiment. At block 802, one or more sound generators can be positioned in the wellbore. At block 804, the one or more sound generators can generate calibration sounds. At block 806, the calibration sounds can be measured by the distributed acoustic sensor. The calibration sounds can be measured with respect to distance along the wellbore of the calibration sounds (e.g., by measuring the length of line 402 in the wellbore when the calibration sound is generated). Some or all of blocks 802, 804, and 806 can be repeated for different distances within the wellbore and different frequencies of calibration sounds, as desired. At block 808, the calibration data can be determined. The calibration data can include a point spread function.

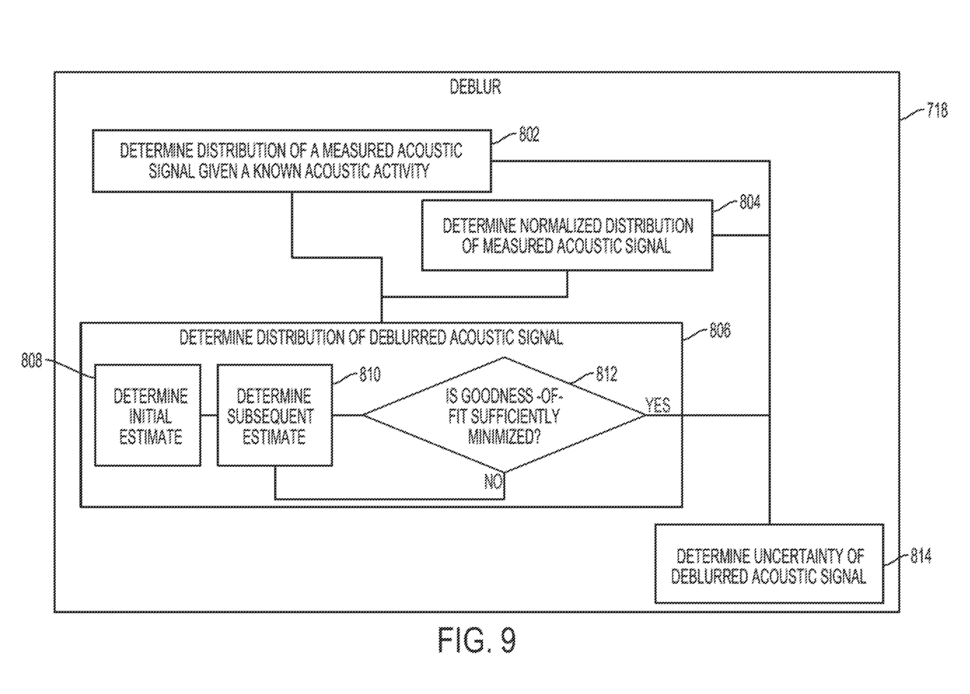

FIG. 9 is a flow chart depicting deblurring according to one embodiment. Other deblurring algorithms can be used besides the one described herein. At block 802, the distribution of a measured acoustic signal given a known acoustic activity is determined, which can include reading the calibration data from a memory (e.g., memory 106). At block 804, a normalized distribution of the measured acoustic signal is determined. At block 806, a distribution of a deblurred acoustic signal (e.g., an enhanced signal) is determined.

Determining the distribution of the deblurred acoustic signal can include determining an initial estimate (e.g., nᵢ⁽⁰⁾ from Equation 3 above) at block 808 and determining a subsequent estimate (e.g., nᵢ⁽¹⁾ from Equation 3 above) at block 810. At block 812, the processor can determine whether the subsequent estimate has a sufficiently minimized goodness-of-fit parameter (e.g., L from Equation 6 above). If the goodness-of-fit parameter is not sufficiently minimized, the process can iterate to determine another subsequent estimate (e.g., nᵢ⁽²⁾ from Equation 3 above) at block 810. If the goodness-of-fit parameter is sufficiently minimized (see Equation 7 above), the most recent estimated distribution of deblurred acoustic signal can be used further (e.g., provided as the enhanced signal).

In some embodiments, the uncertainty of the deblurred acoustic signal can be determined at block 814, using the distribution of the measured acoustic signal given the known acoustic activity from block 802, the normalized distribution of the measured acoustic signal from block 804, and the estimated distribution of the deblurred acoustic signal from block 806.

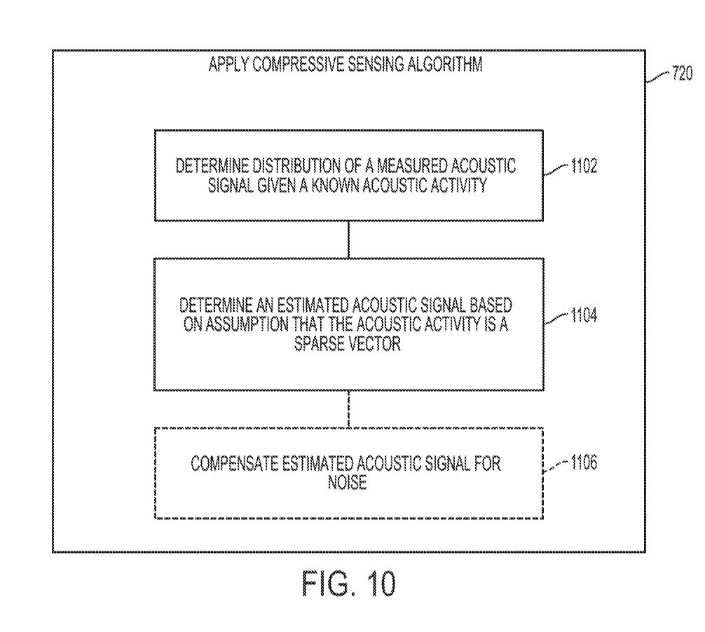

FIG. 10 is a flow chart depicting the application of a compressive sensing algorithm according to one embodiment. Other compressive sensing algorithms can be used besides the one described herein. At block 1102, the distribution of a measured acoustic signal given a known acoustic activity is determined, which can include reading the calibration data from a memory (e.g., memory 106) and using the calibration data to populate the forward mapping matrix D in equation 10. At block 1104, an estimated acoustic signal can be determined based on the assumption that the acoustic activity is a sparse vector, as described above with reference to Equations 10-12.

At optional block 1106, noise can be compensated for as described above with reference to Equation 13.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

What is claimed is:

1. A method, comprising:
measuring an acoustic activity by a distributed acoustic sensor in a wellbore;
providing, by the distributed acoustic sensor, a measured acoustic signal to a processor; and
spatially enhancing the measured acoustic signal by the processor deblurring the measured acoustic signal or applying a compressive sensing algorithm on the measured acoustic signal.

2. The method of claim 1, further comprising calibrating the distributed acoustic sensor by:
generating calibration sounds by a sound generator in the wellbore;
measuring the calibration sounds by the distributed acoustic sensor; and
providing calibration data to the processor based on measuring the calibration sounds.

3. The method of claim 1, further comprising calibrating the distributed acoustic sensor using data from one or more of another wellbore, a digital model, or a physical model.

4. The method of claim 1, wherein spatially enhancing the measured acoustic signal includes deblurring the measured acoustic signal to generate a first enhanced signal and applying the compressive sensing algorithm on the measured acoustic signal to generate a second enhanced signal, the method further comprising comparing the first enhanced signal and the second enhanced signal.

5. The method of claim 1, wherein spatially enhancing the measured acoustic signal includes deblurring the measured acoustic signal to generate a first enhanced signal and applying the compressive sensing algorithm on the first enhanced signal to generate a second enhanced signal.

6. The method of claim 1, wherein:
spatially enhancing the measured acoustic signal includes deblurring the measured acoustic signal; and
deblurring the measured acoustic signal includes:
determining a normalized distribution of the measured acoustic signal;
calculating an initial estimated deblurred acoustic signal;
iteratively calculating a best estimated deblurred acoustic signal; and
providing the best estimated deblurred acoustic signal.

7. The method of claim 1, wherein:
spatially enhancing the measured acoustic signal includes applying the compressive sensing algorithm on the measured acoustic signal; and
applying the compressive sensing algorithm includes determining an enhanced signal, wherein determining the enhanced signal includes minimizing the l₁ norm of the enhanced signal.

8. A system, comprising:
one or more processors;
an distributed acoustic sensor positionable in a wellbore for measuring an acoustic activity and providing a measured acoustic signal to the one or more processors; and
a non-transitory processor-readable storage medium containing instructions that are executable by the one or more processors to cause the one or more processors to perform operations including spatially enhancing the measured acoustic signal by deblurring the measured acoustic signal or applying a compressive sensing algorithm on the measured acoustic signal.

9. The system of claim 8, wherein:
the non-transitory processor-readable storage medium further includes calibration data with information that is based on measurements of calibration sounds by the distributed acoustic sensor; and
spatially enhancing the measured acoustic signal includes using the calibration data from the non-transitory processor-readable storage medium.

10. The system of claim 9, wherein the distributed acoustic sensor includes a fiber optic cable.

11. The system of claim 8, wherein:
the operations include spatially enhancing the measured acoustic signal by deblurring the measured acoustic signal to generate a first enhanced signal and applying the compressive sensing algorithm on the measured acoustic signal to generate a second enhanced signal; and
the non-transitory processor-readable storage medium further includes additional instructions which when executed on the one or more processors, cause the one or more processors to perform additional operations including comparing the first enhanced signal and the second enhanced signal.

12. The system of claim 8, wherein the operations include spatially enhancing the measured acoustic signal by deblurring the measured acoustic signal to generate a first enhanced signal and applying the compressive sensing algorithm on the first enhanced signal to generate a second enhanced signal.

13. The system of claim 8, wherein the operations include spatially enhancing the measured acoustic signal by deblurring the measured acoustic signal, including:
determining a normalized distribution of the measured acoustic signal;
calculating an initial estimated deblurred acoustic signal;
iteratively calculating a best estimated deblurred acoustic signal; and
providing the best estimated deblurred acoustic signal.

14. The system of claim 8, wherein the operations include spatially enhancing the measured acoustic signal by applying the compressive sensing algorithm on the measured acoustic signal including determining an enhanced signal by minimizing the l₁ norm of the enhanced signal.

15. A system comprising:
a fiber optic cable positionable in a wellbore to generate light signals modifications in response to acoustic activity in the wellbore;
a fiber optic interrogator optically coupled to the fiber optic cable and operable to generate a measured acoustic signal based on light signals received from the fiber optic cable;
a memory containing calibration data based on measurements of calibration sounds received by the fiber optic cable;
one or more processors coupled to the fiber optic interrogator and operable to generate a spatially enhanced acoustic signal based on the measured acoustic signal and the calibration data, wherein the spatially enhanced acoustic signal includes at least one from the group consisting of a deblurred first enhanced signal and a second enhanced signal processed by a compressive sensing algorithm.

16. The system of claim 15, wherein the spatially enhanced acoustic signal includes the deblurred first enhanced signal;
the deblurred first enhanced signal is based on the measured acoustic signal and a point spread function; and
the calibration data includes the point spread function.

17. The system of claim 15, wherein the spatially enhanced acoustic signal is based on a comparison of the deblurred first enhanced signal and the second enhanced signal.

18. The system of claim 15, wherein the spatially enhanced acoustic signal includes the deblurred first enhanced signal to which the compressive sensing algorithm has been applied.

19. The system of claim 15, wherein the spatially enhanced acoustic signal includes the deblurred first enhanced signal and the deblurred first enhanced signal is based on a normalized distribution of the measured acoustic signal and an iteratively estimated deblurred acoustic signal.

20. The system of claim 15, wherein:
the spatially enhanced acoustic signal includes the second enhanced signal and the second enhanced signal is based on an enhanced signal for which the l₁ norm has been minimized.
